(19) United States
(12) Patent Application Publication
(10) Pub. No.: US 2005/0237190 A1
(43) Pub. Date: Oct. 27, 2005

(54) Microwave-based intrusion detection systems for vehicles

(76) Inventors: Stephen James Martell, Irlam (GB); Valentinos Michael Vassiliades, Irlam (GB)

Correspondence Address: SWIDLER BERLIN LLP, 3000 K STREET, NW, BOX IP, WASHINGTON, DC, 20007, US

(21) Appl. No.: 10/897,171

(22) Filed: Jul. 23, 2004

(30) Foreign Application Priority Data
Apr. 2, 2004 (GB) 0407549.5

(51) Int. Cl. G08B 13/18

(52) U.S. Cl. 340/552; 340/522

(57) ABSTRACT

A micro-wave based intrusion detector system for use in a vehicle comprising:
a microwave transmitter (10) for creating a volumetric microwave field (12) within a compartment of a vehicle to be protected;
at least two microwave receivers (14a, 14b) adapted to monitor respective volumetric zones (16a, 16b) within the compartment which are predominantly different; and
a signal processor means (22) for comparing the outputs of the microwave receivers (14a, 14b) in order to determine an intrusion.

The present invention relates to microwave-based intrusion detection systems for vehicles and is concerned particularly with a system capable of sensing an intrusion by an object or a person into a specific volumetric zone covering or exceeding a vehicle compartment. Such a compartment could be of any type including the passenger compartment, cargo compartment, trunk and so on, both open and closed.

Existing systems known in the prior-art are based on a variety of technologies including:
1. Ultrasound waves
2. Radio frequency waves
3. Optical waves
4. A combination of two or more such technologies.

However, and regardless of the technology used, all existing systems suffer limitations due to factors such as:
Inherent tradeoffs between sensitivity, coverage, susceptibility to false triggering as well as susceptibility to missing valid events.
Perimeter and physical dependencies such as size, confinement and obstructions.
Susceptibility to false detection caused by interference both normally occurring as well as deliberately introduced for jamming purposes.

There are two primary physical factors that influence the coverage of the compartment to be monitored for intrusions. First are the perimeter's characteristics, which include size, shape, confinement and the nature of its boundaries. The second factor is the topology of the compartment.

The perimeter of the passenger compartment remains a complex factor regardless of the type of waves used due to:
The characteristics of the wave or waves used and the natural factors affecting it such as propagation, attenuation, reflection, absorption and so on.
The propagation of the waves through the glass windscreens and windows. Such propagation causes false triggers by persons or objects outside the area of interest.

Additionally, completely or partially open compartments or windows and soft-top compartments further exacerbate the issues associated with the propagation and coverage of waves.

Intrusion detection systems that are based on radio frequency waves (including Microwaves) are particularly suited for use in vehicle compartments such as the passenger compartment. This is because radio waves are better in covering complex topologies and the passenger compartment topology is dominated by reflective as well as absorbing objects such as seats, metal pillars, non-metal trims and so on.

The use of radiofrequency waves requires the transmission and reception of electromagnetic signals. Methods of achieving compliance with EMC emission regulations are well known and can be achieved through the use of ISM (Industrial, Scientific and Medical) or other licence-exempt bands. Continuous transmission both raw and modulated as well as pulsed modes of transmissions such as ones used in range-gating techniques are also well known and have been extensively used. The problems associated with discontinuous and other modes of transmission due to spurious spectral emissions are well understood and can be resolved to achieve compliancy with emission regulations.

The most prevalent problem with all receivers is their inherent susceptibility to interference. Prior-art methods for reducing or minimising the effect of interference are numerous and they include predominantly measures such as:
Limiting the bandwidth of the receiver to no more than the required signal frequency range. This is generally known as out-of-band rejection.
Controlling or limiting the sensitivity of the receiver.
Limiting the receiver operating time to a duration corresponding to the monitored area. This is generally known as range-gating.

While these methods rely on manipulating the way signals are received, when used in detection systems on their own, they are often insufficient or ineffective in reducing false triggers due to interference. Numerous additional measures have been developed to tackle the problem of false triggers in detection systems and these include measures such as:
Adding information to the transmitted signal that can be used at the post reception end to isolate the signal and/or identify it.
Using additional non-microwave detection technologies to authenticate or augment the detection process.
Controlling the detection threshold according to the level of interference.

There are many examples of microwave Doppler-based motion sensor systems in existence. U.S. Pat. No. 5,986,600 is an example of a pulse Doppler motion sensor implemented using two receivers that provide quadrature signals to detect the direction of the motion. The patent discloses a microwave pulse generator that provides short bursts of RF signals with controlled slopes. A motion detector based on such a sensor is disclosed using range-gating or multiple range-gating.

U.S. Pat. No. 5,966,090 is another example of a pulse Doppler motion sensor that can be implemented using quadrature-configured receivers to provide direction sensing. Gated-region and multiple range-gating implementations are also disclosed. Here a high level of pulse averaging is used to minimise the effect of in-band interference.

Another example of a pulsed Doppler motion sensor is disclosed in U.S. Pat. No. 6,456,231B1. The method used here to minimise the effect of in-band interference relies on separating and measuring the level of the in-band interference. The resultant interference level is then used to determine the detection threshold. An intrusion detection system based on this method is prone to missing valid intrusions in the presence of interference. This is because raising the detection threshold leads to impaired detection sensitivity.

An example of continuous wave (CW) transmission Doppler microwave intruder alarm for vehicles is disclosed in U.S. Pat. No. 5,999,090. The method used to improve the integrity of the detection and to minimise false alarms relies on detecting the interference. Here, the interference detection is based on filtering the Doppler frequencies into two bands one representing mainly intrusions while the other representing interference. The weakness of this type of detection stems from the fact that not all interferences can be isolated.

Other examples of microwave based movement sensors for use in cars are disclosed in U.S. Pat. Nos. 5,227,764 and 4,638,294. U.S. Pat. No. 5,227,764 disclosed a method for a proximity sensor based on the change in the clutter. Such an effect is due to the loading change in the oscillator circuit used to generate the microwave signal. U.S. Pat. No. 4,638,294 uses a similar technique but relies on using the car compartment as a resonant cavity within the oscillator circuit. Both methods are prone to interference and cannot be guaranteed to work only at frequencies confined to permitted bands.

U.S. Pat. No. 6,239,736B1 is an example of a motion detector based on a pulse Doppler gated-region microwave implementation augmented by another detection technology based on Passive Infra Red (PIR) sensing. The aim of the combined technology is to improve the detection integrity. U.S. Pat. No. 5,581,237 and EP0147925A1 are further examples of similar combined technology detection.

Examples of combining microwave and ultrasonic detection technologies are demonstrated in U.S. Pat. Nos. 4,625,199 and 3,801,978. Here again the aim is to improve the rate of false detection.

In accordance with the present invention there is provided a micro-wave based intrusion detector system for use in a vehicle, comprising:
a microwave transmitter for creating a volumetric microwave field within a compartment of a vehicle to be protected;
at least two microwave receivers adapted to monitor respective volumetric zones within said compartment which are predominantly different; and
a signal processing means for comparing the outputs of the microwave receivers in order to determine an intrusion.

Persons or objects that enter one of the covered volumetric zones cause different disturbances to the electromagnetic fields of each zone. For detecting such an intrusion, the disturbances caused to each zone are analysed and compared to each other, and preferably also to reference values.

The comparisons yield a set of measures of these differences and by comparing these measures to predetermined thresholds representing normal conditions a resultant, preferably digital, pattern is obtained. The pattern corresponds to the separated differences in the electromagnetic fields, the comparison means being arranged to examine the extent of the differences in relation to predetermined levels in order for true intrusions to be identified.

Preferably, the microwave transmitter is adapted to transmit an encoded microwave signal for covering the compartment of the vehicle to be protected. The generated electromagnetic field is not necessarily confined to the perimeter of the compartment, but may well extend beyond it in practice because, for example, of glass windscreens and windows or in the case of open-topped vehicles such as sports cars.

Preferably, the frequency of the transmitter is fixed and stabilised such as to comply with regulations regarding the usage of ISM frequency bands.

Preferably, the receivers have circuitry arranged to respond to a selective fixed frequency that corresponds to the transmitted frequency.

To ensure that the receivers recognise the transmission from the system transmitter, the transmitted signal is preferably encoded with a unique code, the receivers each including decoders set to detect the same binary code.

The encoding can be analogue or digital but digital encoding is preferred.

Advantageously, the receivers are each arranged to provide a signal representing a level measurement of the received signal and a digital signal representing the serial transmitted code, the digital decoders associated with the receivers being arranged to compare the received code with the transmitted code and to issue a signal when the two codes match.

The signal processor can then be arranged to:
subtract the level signals received from the two receivers to provide an overall level difference; and
compare this overall level difference with a predetermined value representing an intrusion threshold to give a first digital signal whose state changes if the latter threshold is exceeded.

The signal processor can also be arranged to:
compare the digital signals from the receivers containing the received serial streams to produce a second digital signal when the inputs differ in their logic state,
integrate the serial stream so produced whereby to produce a steady level corresponding to the number of discrete differences found over a fixed period of time; and
compare the steady signal with a further predetermined threshold to produce a third digital signal whose state changes if the latter threshold is exceeded.

The signal processor can be arranged still further to provide a fourth digital signal whenever the digital outputs from the receiver decoders differ in logic state, and to provide a fifth digital signal when the digital outputs from the receiver decoders are in the same logic state.

Two or more of these first to fifth digital signals can then be compared in various ways in a logic circuit in order to arrive at a true intrusion decision.

Preferably, the receivers also provide analogue output signals representing the received signals.

The signal processor can then compare said two analogue output signals from the receivers to provide a clutter difference that can be filtered by one or more filters so as to extract or isolate features, including frequency dependent features, by means of selective filters.

In some embodiments, the phase difference between the transmitted and received signals is extracted and measured.

The phase differences can be compared to a reference value pre-set to equal the longest echo path within the vehicle compartment being monitored, whereby to provide an indication of the proximity of a reflecting body and thereby enable the system to determine valid intrusions.

For detection and prevention of jamming, the level signals can be compared individually to a pre-set value that represents a level higher than the maximum possible under normal conditions whereby to produce two digital signals, jamming detection being indicated by an attempt to trigger the latter signals while the result of the subtraction of the level signals remains zero.

Advantageously, the system includes a timing controller that controls the transmitter such that it transmits short bursts of signal.

A timing signal from the timing controller can then be used such that the received signals are only considered valid during the transmitter active time.

Furthermore, the transmitter inactive time can be used for detecting deliberate jamming or code hijacking attempts when a persistent signal is received.

The invention is described further hereinafter, by way of example only, with reference to the accompanying drawings, in which:—

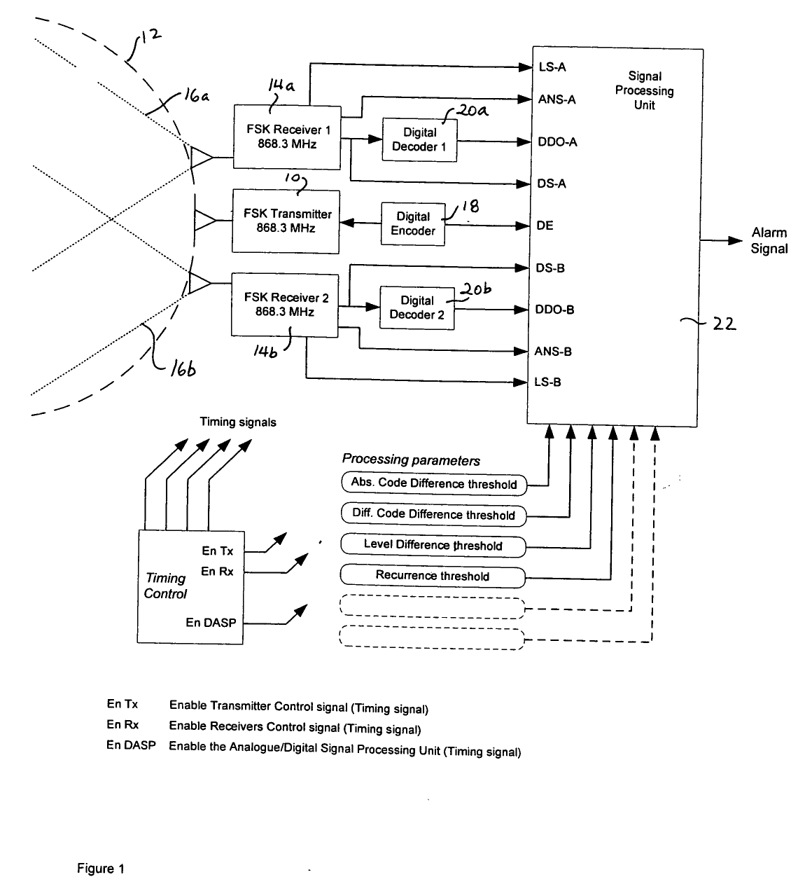

FIG. 1 is a concept illustration and block diagram of one embodiment of a microwave-based intrusion sensor for vehicles in accordance with the present invention;

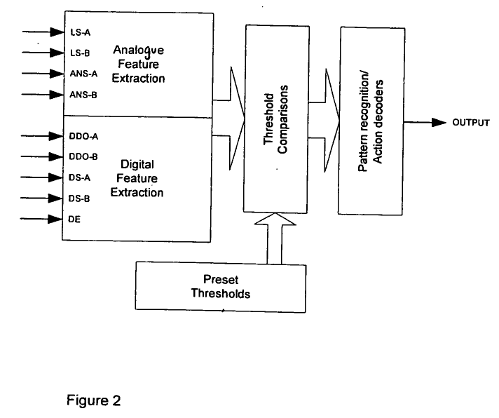

FIG. 2 is a block diagram of the signal processing unit of the embodiment of FIG. 1;

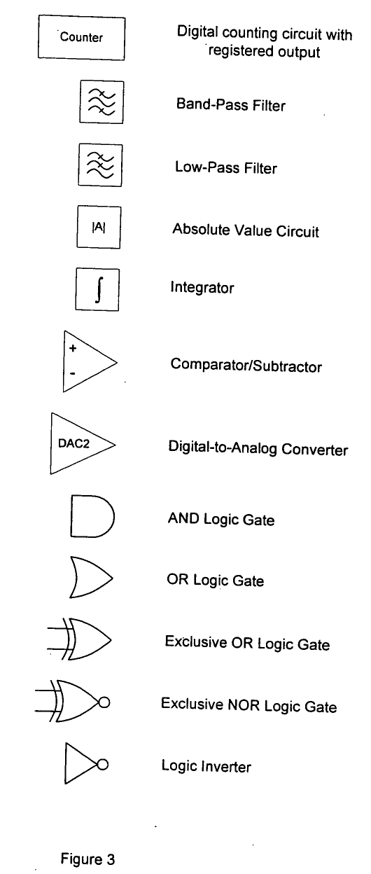

FIG. 3 is a functional description of conventional building blocks used in the present drawings;

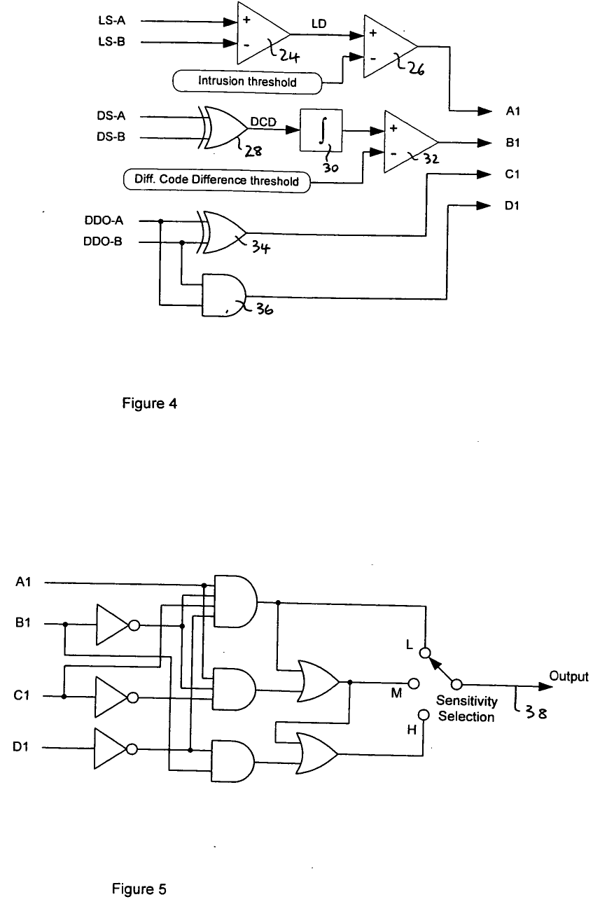

FIG. 4 is a block diagram of a first embodiment of the signal processing unit;

FIG. 5 is a block diagram of an action decoder;

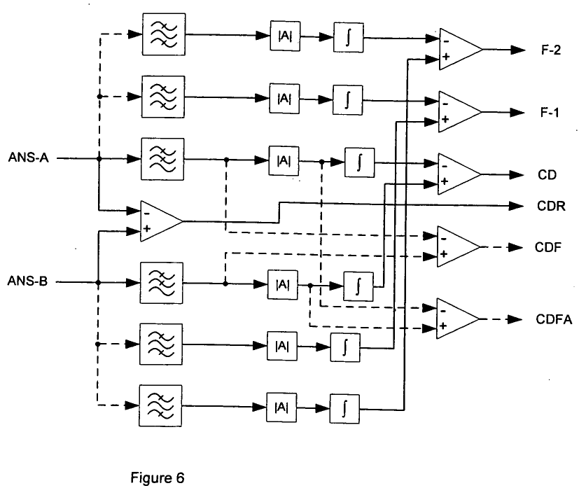

FIG. 6 illustrates the feature-extraction process for the analog signals, including example variants;

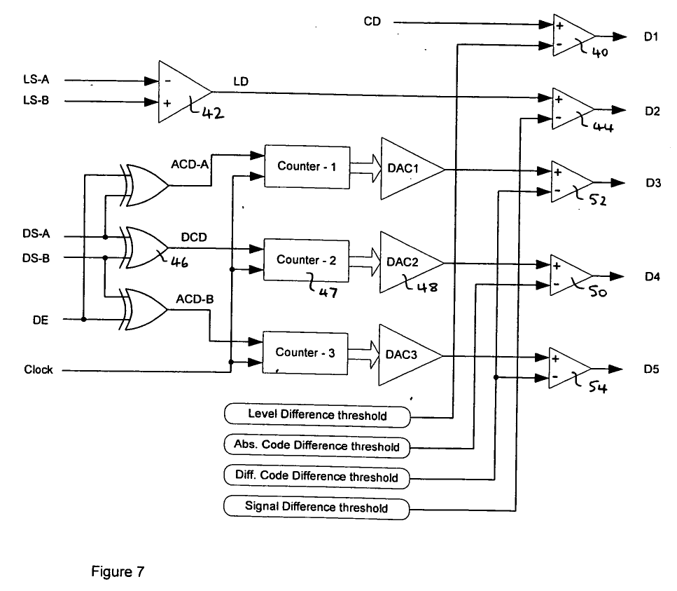

FIG. 7 is a block diagram showing digital signal processing and threshold detection elements of the signal processing unit;

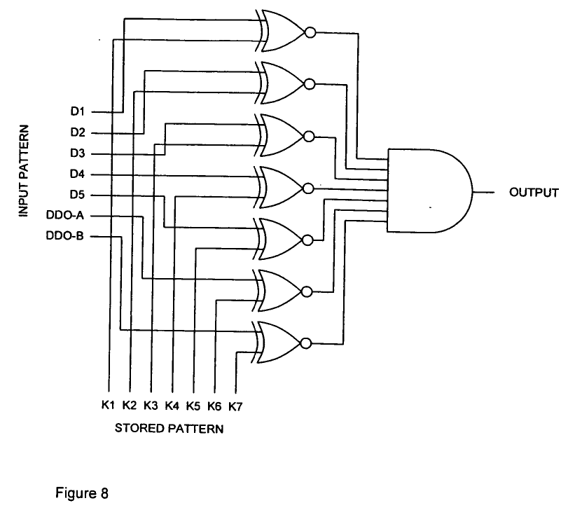

FIG. 8 shows an example of a digital pattern comparison circuit;

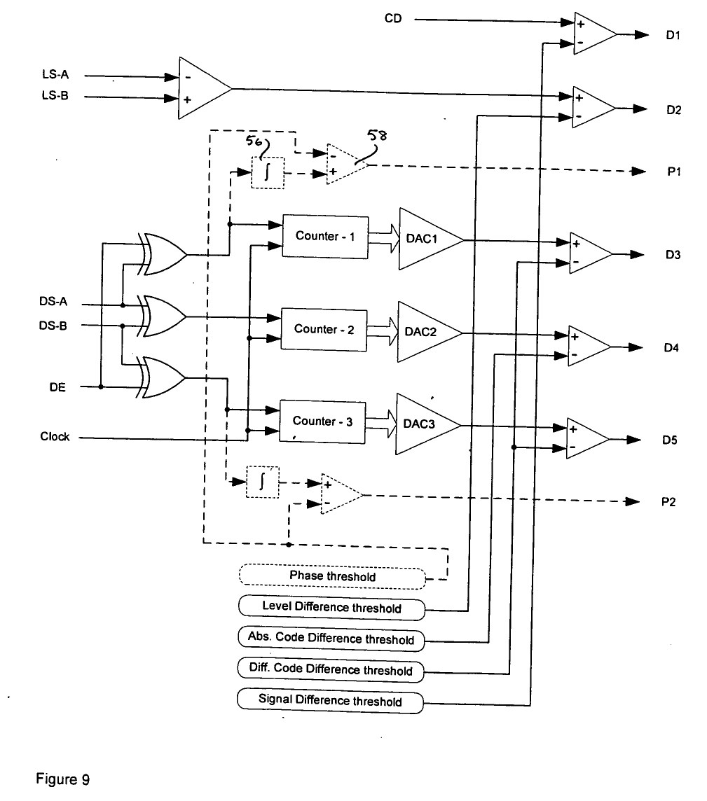

FIG. 9 is a block diagram illustrating the digital signal processing and the threshold detection elements of the signal processing unit and showing added phase processing elements;

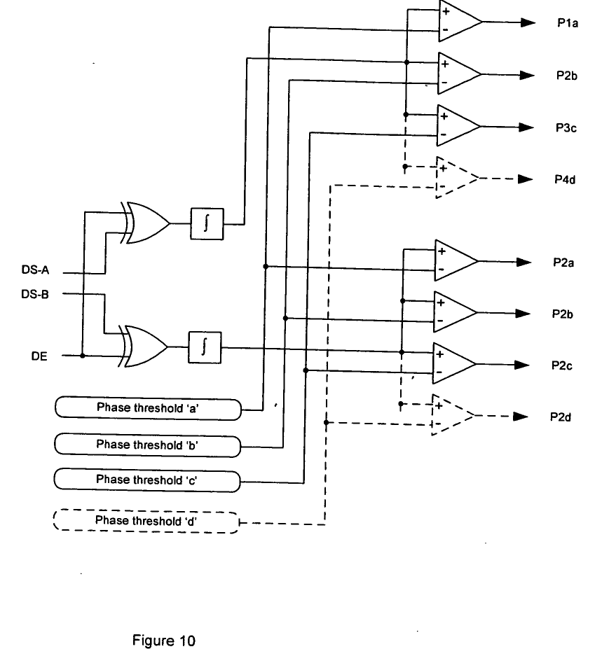

FIG. 10 shows an example of multiple-range implementation; and

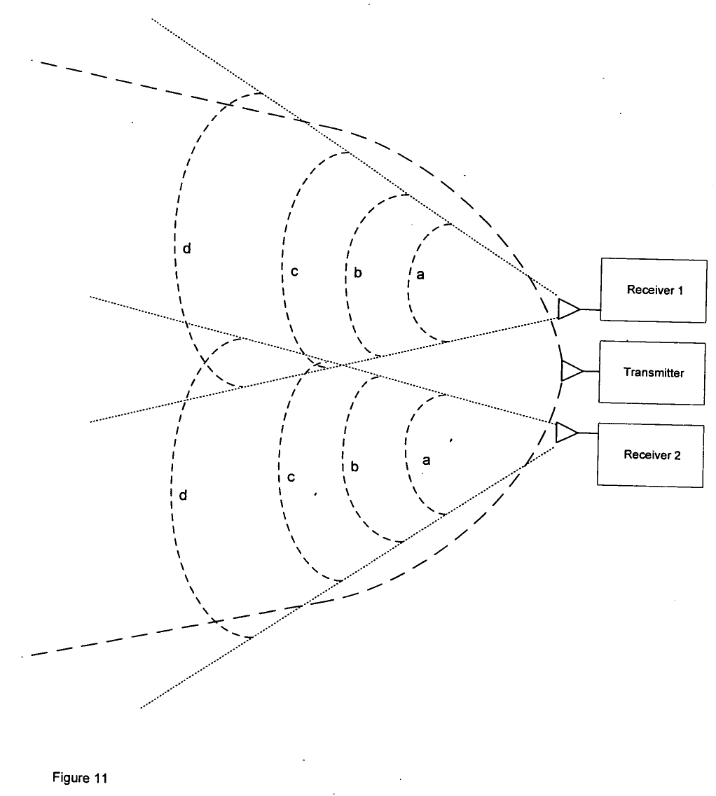

FIG. 11 is an illustration of an embodiment employing four range coverage zones implemented using different phase-difference thresholds.

Referring first to FIG. 1, a digitally encoded signal is generated and transmitted by a transmitter 10 in one direction so as to create a volumetric microwave field 12 covering the passenger compartment of a vehicle (not shown) to be protected. The generated electromagnetic field 12 is not necessarily confined to the perimeter of the passenger compartment, but may well exceed it because of the glass windscreens and windows or in the case of an open-top vehicle such as a sport saloon car. The frequency of the transmitter 10 is fixed and stabilised so as to comply with current regulation regarding the usage of ISM (Industrial, Scientific and Medical) frequency bands.

In this embodiment, two receivers 14a, 14b monitor the resulting electromagnetic field and are capable of receiving any reflected waves. Each receiver 14a, 14b is adjusted to cover a unique volumetric zone 16a, 16b, respectively, with each zone 14a, 14b being directed so as to cover a different volumetric part of the passenger compartment. There can be some overlap between the individual coverage zones. The zones can be placed horizontally, vertically or in any direction in the three-dimensional space.

An intrusion into the vehicle interior is detected because its effect on the respective signals received by the two receivers 14a, 14b is different. This is because of the separate volumetric zones covered by each receiver, which subsequently lead to some differences in the received signals due to absorption, reflections or clutter variations. By contrast, by using a suitably small pre-set detection threshold, any natural disturbance to the electromagnetic fields such as rain, radio interference etc. can be arranged to be rejected (not detected as an intrusion). This is because it would affect both zones 16a, 16b more or less equally and the difference would therefore be well below the pre-set detection threshold.

As explained hereinbefore, the embodiment of FIG. 1 is based on a two-receiver implementation. In the case of a two-zone arrangement, each zone could be made to cover one side of the passenger compartment. Alternatively, the coverage zones can be placed vertically such that one zone covers the volume below the window level while the other covers the volume above the window level.

This particular embodiment is an implementation using the 868.3 MHz ISM band. However, the invention is applicable to any other frequency band as well as implementations that employ more than one permitted ISM band or frequencies within an ISM band or a combination of frequencies and bands.

Each receiver circuit 14a, 14b is designed to have a selective fixed frequency that is set to match the transmitted frequency. This provides a narrow-band frequency coverage that covers the transmitted frequency band with minimum straying beyond the required ISM band. By doing so, the reception of unwanted transmissions from sources other than the system transmitter is minimised.

To ensure that the receivers 14a, 14b only recognise the transmission from the system transmitter 10, the transmitted signal is encoded with a unique code. In the exemplified embodiment, a digital encoder 18 is used to provide the transmitter with a specific binary code that can be set by the user. On the receiving side, the receivers 14a, 14b have respective decoders 20a, 20b set to detect the same binary code. The decoders 20a, 20b used at the receiving ends must obviously match whatever method of encoding is used at the transmitter end. The following applies:
There are no restrictions on the type of encoding that can be used both analogue and digital. Digital encoding however, is the preferred type due to its well-known and acknowledged high degree of immunity to noise and interference.
There are no restrictions on the type of digital encoding method that can be used. FSK (frequency shift keying) is the preferred encoding type used in the example embodiment but other types such as ASK, PSK etc. are all applicable and can be used.
All methods of code scanning and code-hijacking preventions can be used. For example, random-code, rolling-code, hopping-code etc can all be used as well as frequency and channel hopping techniques.
There are no restrictions on the combination of such methods that can be used in any one system.

Each receiver 14a, 14b provides:
Analogue signal output representing the received signal (ANS).
A signal representing a level measurement of the received signal (LS).
A digital signal representing the serial transmitted code (DS).

Each digital decoder 20a, 20b compares the received code with the transmitted code and issues a signal (DDO) when the two codes match.

In the exemplified embodiment, the signals corresponding to the two-receiver implementation are:

| | |
|---|---|
| ANS-A | Analogue signal from receiver 14a |
| LS-A | Level signal from receiver 14a |
| DS-A | Digital signal from receiver 14a containing |
| | the received serial stream |
| DDO-A | Digital signal from decoder 20a |
| DE | Digital signal from the encoder containing |
| | the transmitted serial stream. |
| ANS-B | Analogue signal from receiver 14b |
| LS-B | Level signal from receiver 14b |
| DS-B | Digital signal from receiver 14b containing |
| | the received serial stream |
| DDO-B | Digital signal from decoder 20b |

The signals from all the receivers, decoders as well as the transmitter encoder 18 (DE) are fed to a signal-processing unit 22. FIG. 2 shows the various basic elements typically used in the construction of the signal-processing unit 22. The number and combinations of such elements depend on the complexity of the detection task required as will be shown in the example embodiments described hereinafter. Each section within the signal-processing unit contains a circuit constructed using some of the standard functional elements listed in FIG. 3.

Based on a two-receiver implementation a number of signal-processing implementations are possible as demonstrated by the following two examples.

### EXAMPLE 1

### A Simple Signal-Processing Implementation Based on Extracting a 4-Bit Pattern

In this example, the received analogue signals ANS-A and ANS-B are not used as shown in FIG. 4. This signal-processing unit performs the following operations:
1. Subtracts the two level signals (LS-A and LS-B) in a subtracting element 24 and provides an overall level difference (LD). The level difference LD is then compared to a pre-set value representing the “Intrusion threshold” using a comparator 26 giving a digital output signal A1. If LD exceeds the pre-set threshold, the digital signal (A1) changes its voltage level. The change in voltage level represents a change in logic state from zero (0) to one (1).
2. DS-A and DS-B are compared using an exclusive-OR gate 28 that produces a digital signal DCD whenever the inputs differ in logic state. The serial stream produced is then integrated at 30 so as to produce a steady level corresponding to the number of discrete differences found over a fixed period of time. The integration time interval corresponds to the transmitter active time. The steady signal is then compared to a pre-set threshold value using a comparator 32, which produces a digital signal B1 in a similar manner as described in 1.
3. The digital outputs DDO-A and DDO-B from the two decoders 20a, 20b are processed in two different ways. First an Exclusive-OR 34 provides a digital signal C1 whenever the two inputs differ in logic state. Second, an AND gate 36 provides a digital signal D1 whenever the two inputs are at logic ‘1’.
4. The four digital signals A1, B1, C1 and D1 form a digital pattern with 16 theoretical states. However only 12 states are possible since it is not possible for C1 and D1 to be at logic ‘1’ simultaneously.

5. The detected activity corresponding to each pattern is determined by the conditions that give rise to that pattern. These conditions are examined and verified by prior controlled measurements, which establish the settings for the thresholds. The action based on these detected or suspected activities can be made to depend on the desired level of sensitivity. Table 1 shows an example of such groupings based on three levels of sensitivities.

TABLE 1
The Logic Pattern States and their
Associated Conditions

| | | | | | Action at sensitivity | | |
|---|---|---|---|---|---|---|---|
| | | | | | Y = Intrusion | | |
| | | | | | is detected | | |
| A1 | B1 | C1 | D1 | Activity Indication | High | Normal | Low |
| 0 | 0 | 0 | 0 | No activities | — | — | — |
| 1 | 0 | 0 | 0 | Likely intrusion | Y | Y | — |
| 0 | 1 | 0 | 0 | Possible intrusion | Y | — | — |
| 1 | 1 | 0 | 0 | Suspected intrusion | Y | — | — |
| 0 | 0 | 1 | 0 | Distant reflections | — | — | — |
| 1 | 0 | 1 | 0 | Intrusion | Y | Y | Y |
| 0 | 1 | 1 | 0 | Possible intrusion | Y | — | — |
| 1 | 1 | 1 | 0 | Suspected intrusion | Y | — | — |
| 0 | 0 | 0 | 1 | Interference | — | — | — |
| 1 | 0 | 0 | 1 | Likely intrusion | Y | Y | — |
| 0 | 1 | 0 | 1 | Interference | — | — | — |
| 1 | 1 | 0 | 1 | Jamming | — | — | — |

| | | | | |
|---|---|---|---|---|
| 0 | 0 | 1 | 1 | NOT POSSIBLE |
| 1 | 0 | 1 | 1 | |
| 0 | 1 | 1 | 1 | |
| 1 | 1 | 1 | 1 | |

6. The logic circuit shown in FIG. 5 performs the groupings of the patterns and provides an output signal on line 38 that indicates a valid intrusion according to the selected sensitivity level.

### EXAMPLE 2

### A Signal-Processing Implementation Based on Extracting Additional Features from the Received Signals

This example demonstrates the implementation of a more complex signal-processing unit based on extracting additional features to those shown in the previous example. This signal-processing unit performs the following operations:
Compare the two analogue signals (ANS-A and ANS-B) and provide a clutter-difference that can be filtered using one or more filters so as to extract or isolate features including frequency-dependant ones by using selective filters. Each extracted feature is then rectified and smoothed to produce a dc measure. The rectification is accomplished by means of an absolute value conversion circuit while a low pass filter or integrator circuit achieves the smoothing. A number of features can be extracted from ANS-A and ANS-B as shown in FIG. 6. These features include:
   a. CDR, which is the raw difference signal obtained from the direct subtraction of ANS-A and ANS-B prior to any filtering, rectification and smoothing. This signal represents the broadband differential clutter from the two zones examined.
   b. CD, which is the differential clutter level obtained from the subtraction of ANS-A and ANS-B after low-pass filtering, rectification and smoothing of each.
   c. CDF, which is the differential clutter obtained by subtracting the low-pass filtered ANS-A and ANS-B. This signal represents the narrow-band differential clutter from the two zones examined.
   d. CDFA, which is the differential clutter obtained by subtracting the rectified received analogue signals. This signal represents a unipolar form of the band-limited differential clutter.
   e. F-1 and F-2, which are two examples of band-selective differential clutters.

FIG. 7 shows the remainder of the feature extraction part of the signal-processing unit 22. However, only one feature from the previous part namely CD is used. This is sufficient to demonstrate how the various features that can be extracted from ANS-A and ANS-B are utilised. The operations performed by this part of the signal-processing unit are:
Compare CD to a preset threshold using a comparator 40 to provide a digital signal D1. If CD exceeds the pre-set threshold the digital signal (D1) changes its voltage level. The change in voltage level represents a change in logic state from zero (0) to one (1).
Subtract the two level signals (LS-A and LS-B) at a subtractor element 42 and provide an overall level difference (LD) in the same manner as described in the first example. The level difference LD is then compared in a comparator 44 to a pre-set value representing the “Level difference threshold” which is equivalent to the “Intrusion threshold” used in the first example. If LD exceeds the pre-set threshold the digital signal (D2) changes its voltage level. The change in voltage level represents a change in logic state from zero (0) to one (1).
DS-A and DS-B are compared using an exclusive-OR gate 46 that produces a digital signal DCD whenever the inputs differ in logic state. This is exactly the same as in the first example, but however a different method of obtaining a cumulative measure is used. Here, a digital counter 47 with registered output is used as an accumulator for the pulse stream when the transmitter is active. Thus at the end of the transmitter-active period, the resultant output would represent a certain measure of the differential bit-difference. The value obtained is then converted using a Digital-to-Analogue Converter for example, and then compared in a comparator 50 to a pre-set threshold. The comparator 50 provides a digital signal D4.
DS-A and DS-B are compared individually to DE in exactly the same manner as used for the differential bit-difference described previously. The outcome of these operations represents a measure of the absolute code differences that can be compared individually to a specific pre-set threshold. These operations provide two digital signals D3 and D5 via comparators 52, 54 as shown in FIG. 7.
Although the digital outputs DDO-A and DDO-B from the two decoders 20a, 20b can be processed in a similar manner to that described in the first example, in this example however, both will be used directly in order to demonstrate an alternative method of implementation.
The five digital signals (D1 to D5) from the comparators 40, 44, 52, 50 and 54 together with the outputs of the two decoders (DDO-A and DDO-B) 20a, 20b forms a 7-bit binary pattern representing a set of indications. This binary pattern is then compared to a set of pre-conditions corresponding to the patterns from measured intrusions. The digital comparator used to compare the pattern comprises one or more circuits as shown in FIG. 8. The digital comparator circuit shown in FIG. 8 is however only one example out of numerous possible implementations of such a function.
A number of patterns can be isolated and identified to represent a particular set of conditions. These patterns can then be grouped in a similar manner to that described in the first example and assigned to a particular level of sensitivity that determines the required action.

### EXAMPLE 3

### Adding Extracted Phase Information to the Signal-Processing Implementation

Since the transmitted signal is digitally encoded, then the phase difference between the transmitted and the received signals can be extracted and measured. This phase information represents the time-of-flight since the electromagnetic wave travels at speed approximately equal to the speed of light. Hence, the time duration corresponding to the phase difference represents the distance travelled by the serially coded signal from the transmitter to the reflecting object and back to the receiver. By comparing the obtained phase differences to a reference value pre-set to equal the longest echo path within the passenger compartment of the vehicle, an indication of the proximity of the reflecting body is obtained. In this way, signals due to reflecting objects outside the car can be detected. Furthermore, signals from a reflecting object closer than normal can also be detected. The ability to detect the proximity of reflecting objects to the transmitter allows the intrusion system to determine which ones constitute valid intrusions.

An example implementation is shown in FIG. 9, which shows how the phase extraction process is added to the digital signal processing part previously shown in FIG. 7. Here the serial stream produced by comparing the received digital code DS-A from the first receiver to the transmitted digital DE is processed directly using an integrator 56. The integrator time constant is set to be equal or larger than the transmitter active time such that it produces a dc level that is proportional to the phase difference between the two streams. A comparator 58 then provides P1 whenever this value exceeds a preset phase threshold.

A second digital bit P2 is calculated in exactly the same way to represent the phase difference between DS-B and DE.

The two digital bits P1 and P2 are then considered as part of the normal digital pattern described previously in the second example.

An alternative implementation of the phase-difference information is shown in FIG. 10, whereby each signal is compared to several thresholds representing different time-of-flight. The main advantage of such an arrangement is to split the range of detection into zones with specific perimeters as illustrated in FIG. 11.

Detection and Prevention of Jamming:

Another action within the signal-processing unit can be included to prevent deliberate attempts to disable the intrusion system by signal jamming. This is accomplished by monitoring each level signal (LS-A and LS-B) and comparing it to a pre-set value that represent a level higher than the maximum possible under normal conditions. This produces two digital signals (AJ-A and AJ-B). A jamming attempt will trigger AJ-A and AJ-B while LD remains zero, which indicates a jamming detection.

Additional Features:

A timing controller can control the transmitter 10 such that it transmits short bursts of signal rather than continuously. The bursts can be periodic or random and apart from minimising the current consumption, this provides a defined valid-time pattern for the signal. The timing signal is also supplied to the signal-processing unit such that the signals are considered valid only during the transmitter active time. The transmitter inactive time is also useful in detecting deliberate jamming or code hijacking attempts whenever a persistent signal is received.

If such detection is not required, the timing signal could be used to control the receivers such that they are enabled only when the transmitter is active.

When an intrusion is detected during a transmitter active period, it can be treated as a suspected intrusion to be confirmed if the next transmitter active period shows the same. Such a recurrence scheme can be extended such that an intrusion is only considered valid if it is detected over a predetermined number of successive transmitter active periods.

It is important to appreciate that an embodiment can be made using some of the signal processing features outlined above rather than all of them. Also, the number of signal processing parameters that are utilised in any particular embodiment depends on the nature and complexity of the passenger compartment, the type of vehicle to be protected as well as the nature and level of intrusion protection required.

Furthermore, this invention provides a means to increase the detection certainty in otherwise difficult passenger compartments because there is no limit on the number of receivers that can be deployed to further split the detection zones.

1. A microwave based intrusion detector system for use in the vehicle comprising:
a microwave transmitter for creating a volumetric microwave field within a compartment of a vehicle to be protected;
at least two microwave receivers adapted to monitor respective volumetric zones within said compartment which are predominantly different; and
a signal processor means for comparing the outputs of the microwave receivers in order to determine an intrusion.

2. A system as claimed in claim 1, wherein the result of the comparison of the outputs of the microwave receivers is itself compared with one or more predetermined thresholds in order for true intrusions to be identified.

3. A system as claimed in claim 1, wherein the transmitter is adapted to transmit an encoded microwave signal to the compartment of the vehicle to be protected.

4. A system as claimed in claim 1, wherein the frequency of the transmitter is fixed and stabilized to comply with standing regulations.

5. A system as claimed in claim 4, wherein the receivers have circuitry arranged to respond to a selectable fixed frequency that corresponds to the transmitted frequency.

6. A system as claimed in claim 1, wherein the signal transmitter is encoded.

7. A system as claimed in claim 6, wherein the receivers include respective decoders such that the receivers only respond to transmissions from the system transmitter.

8. A system as claimed in claim 6, wherein the encoding is digital.

9. A system as claimed in claim 8 in which the receivers are each arranged to provide a signal representing a level measurement of the received signal and a digital signal representing the serial transmitted code, the digital decoders associated with the receivers being arranged to compare the received code with the transmitted code and to issue a signal when the two codes match.

10. A system as claimed in claim 9, in which the signal processor is arranged to:
subtract the level signals received from the two receivers to provide an overall level difference; and
compare this overall level difference with a predetermined value representing an intrusion threshold to give a first digital signal whose state changes if the latter threshold is exceeded.

11. A system as claimed in claim 10, in which the signal processor is arranged to:
compare the digital signals from the receivers containing the received serial streams to produce a second digital signal when the inputs differ in their logic state,
integrate the serial stream so produced whereby to produce a steady level corresponding to the number of discrete differences found over a fixed period of time; and
compare the steady signal with a further predetermined threshold to produce a third digital signal whose state changes if the latter threshold is exceeded.

12. A system as claimed in claim 10, in which the signal processor is adapted to provide a fourth digital signal whenever the digital outputs from the receiver decoders differ in logic state, and to provide a fifth digital signal when the digital outputs from the receiver decoders are in the same logic state.

13. A system as claimed in claim 10, wherein two or more of said first to fifth digital signals are compared in a logic current to arrive at a true intrusion decision.

14. A system as claimed in claim 9, wherein the receivers also provide analogue output signals representing the received signals.

15. A system as claimed in claim 14, wherein the signal processor compares said two analogue output signals from the receivers to provide a clutter difference that can be filtered by one or more filters so as to extract or isolate features, including frequency dependent features, by means of selective filters.

16. A system as claimed in claim 15, wherein the extracted features are rectified and smoothed to produce a d.c. measure.

17. A system as claimed in claim 15, wherein the two analogue signals are subtracted prior to filtering, rectification and smoothing to provide a signal representative of the broadband differential clutter from the two zones being monitored.

18. A system as claimed in claim 15, wherein two analogue signals are subtracted after filtering, rectification and smoothing to provide a differential clutter level.

19. A system as claimed in claim 15, wherein the two analogue signals are subjected to low pass filtering and subtraction to provide a signal representative of narrow-band differential clutter from the two zones being monitored.

20. A system as claimed in claim 15, wherein the two analogue signals are subjected to rectification and subtraction to provide a signal representative of a unipolar form of band-limited differential clutter.

21. A system as claimed in claim 6, wherein the phase difference between the transmitted and received signals is extracted and measured.

22. A system as claimed in claim 21, wherein the phase differences are compared to a reference value pre-set to equal the longest echo path within the vehicle compartment being monitored, whereby to provide an indication of the proximity of a reflecting body and thereby enable the system to determine valid intrusions.

23. A system as claimed in claim 9, wherein for detecting and prevention of jamming, the level signals are compared individually to a pre-sent value that represents a level higher than the maximum possible under normal conditions whereby to produce two digital signals, jamming detecting being indicated by an attempt to trigger the latter signals while the result of the subtraction of the level signals remains zero.

24. A system as claimed in claim 1 including a timing controller that controls the transmitter such that it transmits short bursts of signal.

25. A system as claimed in claim 24, wherein a timing signal from the timing controller is used such that the received signals are only considered valid during the transmitter active time.

26. A system as claimed in claim 24, wherein the transmitter inactive time is used for detecting deliberate jamming or code hijacking attempts when a persistent signal is received.

27. A system as claimed in claim 24, wherein when an intrusion is detected during a transmitter active period, it is treated as a suspected intrusion to be confirmed if the next transmitter active period shows the same.

28. A system as claimed in claim 27, wherein an intrusion is only considered valid if it is detected over a pre-determined number of successive transmitter active periods.

29. A micro-wave based intrusion detector system substantially as hereinbefore described, with reference to and as illustrated in any of the accompanying drawings.
